(19) United States
(12) Patent Application Publication
(10) Pub. No.: US 2014/0166291 A1
(43) Pub. Date: Jun. 19, 2014

(54) SURFACTANT SYSTEM AS A SELF-DIVERTED ACID FOR WELL STIMULATION

(71) Applicant: SANJEL CANADA LTD., Calgary (CA)

(72) Inventors: Dawn FRIESEN, Calgary (CA); Sally LAWRENCE, Calgary (CA)

(73) Assignee: SANJEL CANADA LTD., Calgary (CA)

(21) Appl. No.: 14/106,194

(22) Filed: Dec. 13, 2013

Related U.S. Application Data
(60) Provisional application No. 61/737,202, filed on Dec. 14, 2012.

(51) Int. Cl. C09K 8/584; E21B 43/26

(52) U.S. Cl. CPC C09K 8/584; E21B 43/26
USPC 166/307; 507/240

(57) ABSTRACT

A composition for acid stimulation of a subterranean formation, which is an acidizing fluid including a sulfobetaine surfactant, a polymeric associative thickener, and a short chain alcohol. The acidizing fluid comprises sufficient acid so as to be non-viscous when pumped into a wellbore and becomes viscous as acid is consumed by reaction with formation components and pH of the fluid rises.

### CROSS REFERENCE TO RELATED APPLICATIONS

This application claims the priority benefit of U.S. Provisional Patent Application No. 61/737,202 filed on Dec. 14, 2012 entitled “Surfactant System as a Self-Diverted Acid for Well Stimulation”, the contents of which are incorporated herein by reference.

### FIELD OF THE INVENTION

The present invention relates to a composition and a method for diverting acid in a subterranean reservoir treatment process.

### BACKGROUND

Stimulation is performed on a hydrocarbon well to increase or restore production. Sometimes, a well initially exhibits low permeability, and stimulation is employed to commence production from the reservoir. Other times, stimulation is used to further encourage permeability and flow from an already existing well that has become under-productive.

Well acidizing is a stimulation technique that attempts to restore the natural permeability of the reservoir rock. Well acidizing is achieved by pumping acid into the well to dissolve limestone, dolomite and calcite cement between the sediment grains of the reservoir rocks. There are two types of acid treatment: matrix acidizing; and fracture acidizing.

Matrix acidizing involves pumping acid into the well and into the pores of the reservoir rocks. The acids dissolve the sediments and mud solids that are inhibiting the permeability of the rock, thereby enlarging the natural pores of the reservoir and stimulating the flow of hydrocarbons. Matrix acidizing is performed at sufficiently low pressures to avoid fracturing the reservoir rock. In contrast, fracture acidizing involves pumping highly pressurized acid into the well, thereby physically fracturing the reservoir rock and dissolving the permeability inhibitive sediments. Fracture acidizing forms channels through which the hydrocarbons can flow.

Different acids are used to acidize wells. Strong inorganic acids are predominately used. Hydrochloric acid (HCl) is particularly useful in removing carbonate residues, or limestones and dolomites, from the reservoir rock. Also, HCl can be combined with a mud acid, or hydrofluoric acid (HF), and used to dissolve quartz, sand and clay from the reservoir rocks.

Several methods have been developed to permit selective acid stimulation of low permeability carbonate zones. Mechanical devices used to isolate particular regions of a fonnation prior to acid treatment are described in the literature (see N. W. Harrison: “Diverting agents—History and application”, Journal of Petroleum Technology, May 1972, 593-598). Chemical means for acid diversion are also used. One of the simplest methods involves the suspension of a solid diverting agent in the acidizing fluid. Upon entering the formation, these solids plug developing wormholes to form a physical barrier and thereby slow the influx of acid and divert fluid flow to less stimulated areas of the formation. In some cases, the diverting agent may instead form a fine filter cake across high permeability formation faces, thereby directing unspent acid towards less permeable zones. An early additive for acid diversion was rock salt, but the use of benzoic acid flakes has become more common, and many other additives are known. Removal of these solid diverting agents usually involves allowing flow back of formation water or hydrocarbon fluid from the well to dissolve the additives, but this is often inefficient and material remaining in the formation can result in permanent formation damage and production loss.

As an alternative to external diverting agents, acidization of carbonate formations has also been performed using gelled acids in which the viscosity of the treatment fluid is used to control the rate and location of reactivity. Incorporation of cross-linked polymers into aqueous acid solutions produces a high viscosity gel that is stable through a wide working temperature range and is capable of retarding the reaction of acid with matrix rock. In one such application, a linear polymer is cross-linked by addition of a multivalent metal cation such as iron or zirconium, resulting in an increase in the viscosity of the treatment fluid. Once the treatment is complete, gel breaking additives reduce the solution viscosity to facilitate removal of the spent acid. However, removal of polymer residue from the formation following treatment is a major concern for these systems due to the relatively poor water solubility of the guar-derived or polyacrylamide polymers commonly employed in this process. Significant polymer retention by formations has been observed with a dramatic negative impact on the long term productivity of wells due to loss of core permeability. The multi-component nature of cross-linked polymer gels can also give rise to unwanted chemical interactions between gel additives and the formation rock or well tubulars that precipitate solid products which can reduce formation permeability. In many cases, such as the precipitation of an iron cross-linking agent at high temperatures, or the formation of solid iron sulfides, these precipitates may be impossible to remove due to incompatibilities between the required treatment and the formation.

Cross-linked polymer gels also pose several operational challenges that can affect. treatment success. Proper hydration of the linear polymer prior to cross-linking and well treatment is essential for developing of the expected fluid properties and avoiding the introduction of additional polymer residue into a formation. This hydration time must be included in the treatment schedule and requires additional equipment to be located at the well site. Polymer systems that develop high viscosity at the surface prior to wellbore injection are more difficult to pump downhole. Systems that delay cross-linking allow solutions to maintain low surface viscosities and thus be more easily delivered to the formation face. However, it can be difficult to ensure the proper gelation delay due to the influence of wellbore temperature and formation chemistry.

The use of gelled fluids for selective acidization of carbonate reservoirs requires that the gel can be selectively placed in known high permeability areas of the formation. Following gel placement, the formation is treated with a non-gelled acid which is diverted to low permeability areas that do not contain the polymer gel. Although the use of gelled fluids provides considerable control over the amount of acid delivered across a formation face, it requires a detailed knowledge of the matrix composition and permeability to ensure accurate gel placement, which can itself require a considerable investment of time and resources. A significant improvement on this design lies in the area of self-diverted acids, in which the treatment fluid changes viscosity in response to reaction with the formation it contacts. In practice, this has been achieved through the use of surfactant-based acidization fluids which vary their viscosity as a function of solution pH and ion content.

Polymer-free, water-based gelled acids may be prepared using surfactants. Surfactants are compounds that contain both polar and non-polar segments and demonstrate surface activity in solution. The surfactants themselves can be cationic, anionic, zwitterionic, or non-ionic. Above a critical concentration, surfactants in aqueous solution may form micelles, which are commonly spherical or semi-spherical in shape. Modifying the pH and ionic strength of certain surfactant solutions can cause the micelles to lose their spherical shape and form elongated “worm-like” micelles that become entangled with each other resulting in an increased fluid viscosity and elasticity. This property has lead to the application of viscoelastic surfactant-based gels as self-diverting acids for treatment of carbonate formations.

When a surfactant fluid comprising a strong acid is injected into the formation, the acid reacts rapidly with the rock (primarily limestone, CaCO₃, or dolomite, CaMg(CO₃)₂), resulting in consumption of the acid and an increase in the pH and ionic strength of the fluid at the rock face. Once the pH reaches a critical value, usually 2 to 4 (depending on the surfactant), worm-like micelles form and become entangled, increasing the viscosity of the solution and slowing acid consumption in the immediate area. In this way, the initial rapid uptake of treatment fluid by high permeability sections of a formation is slowed, and fresh fluid is diverted to areas of lower permeability, resulting in a more even treatment of the formation. Reducing the viscosity of the spent acid may be accomplished by dilution of the treatment fluid with formation water or contact with crude oil or condensates. Flushing the well bore with a mutual solvent prior to and following treatment has also been used to speed viscosity reduction, but effective contact of the gelled acid with mutual solvent is difficult to achieve. The addition of a separate breaker may be necessary to reduce the required break time.

Surfactant-based acidization fluids offer significant advantages over the use polymer-based gels as diverted acids. The most notable advantage is the self-diverting nature of the surfactant solutions: viscosity development as a function of fluid pH allows for precise placement of diverting gel in areas of high permeability and results in selective treatment of low permeability/high damage areas to ensure more homogeneous treatment of a formation. Another major advantage is the solubility of the surfactant which remains in solution throughout the treatment process. This enables complete removal of the surfactant from the wellbore with essentially no damage to the formation as a result of fluid residue, which results in high retained conductivity following well treatment. Operationally, the low viscosity of the solution during injection and fluid removal stages reduces friction wear on pumps and tubulars. Most surfactant based systems are also compatible with common foaming agents (N₂ and CO₂) and can be delivered as foams to reduce base fluid requirements and treat water sensitive formations.

The many desirable properties displayed by surfactant-based self-diverting acids are limited by the small number of surfactants that undergo a pH driven shift from spherical to worm-like micelles, thus limiting the ability to optimize acid stimulation of a given well based on formation chemistry. Breaking the surfactant gel after treatment also poses a challenge, as dilution by formation fluids is not necessarily an efficient breaking method as it may require long well shut-in times that are not economically viable. Furthermore, self-diverting acids based on the formation of worm-like micelles are adversely affected by the presence of ferric iron which severely decreases the apparent gel viscosity. Avoiding contact of well treatment fluids with ferric iron requires additional measures such as the use of acid with low iron content, clean tanks for acid mixing, and pickling of all well tubulars before the acidization treatment, thus complicating the treatment schedule and adding to equipment and chemical costs.

### SUMMARY OF THE INVENTION

In general, the invention may comprise a system which provides a fluid that is not viscous in live acid, such as a hydrochloric acid blend that would be pumped down a well bore on an acid stimulation job, but which becomes viscous when the acid reacts with the rock formation. Preferably, the viscous fluid then loses its viscosity as the acid is consumed and pH continues to rise.

In one aspect, the invention comprises a fluid composition for acid stimulating a formation, comprising:
(a) an aqueous medium comprising an acid;
(b) a primary surfactant comprising a sulfobetaine which forms non-elongated micelles at a pH of between about 0.1 to about 5.0;
(c) an associative thickener comprising a polymer comprising a hydrophobic group and a hydrophilic group; and
(d) a short chain alcohol.

In one embodiment, the composition further comprises a secondary surfactant, which may comprise an anionic or non-ionic surfactant. In one embodiment, the secondary surfactant comprises a compound having the formula: HO—Y—R³, in which R³ is selected from linear or branched C₁₆-C₂₂-alkyl, C₁₆-C₂₂-alkenyl, C₁₆-C₂₂-alkynyl, (C₁₅-C₂₁-alkyl)carbonyl, (C₁₅-C₂₁-alkenyl)carbonyl and (C₁₅-C₂₁-alkynyl)carbonyl, and Y is a group consisting of 1 to 20 alkyleneoxy units, or a precursor thereof.

In one embodiment, the short chain alcohol may comprise a primary or secondary alcohol having 3 to 10 carbon atoms, and preferably having 4 to 8 carbon atoms, and may comprise 2-ethyl-1-hexanol, n-hexanol, or n-octanol.

In one embodiment, the sulfobetaine comprises a compound having the formula:

R¹—N⁺(R²)₂—X—SO₃⁻

in which R¹ is a hydrophobic group having between 10 to 24 carbon atoms, and may be branched or straight chained, saturated or unsaturated, and may include a carbonyl, an amide, a retroamide, an imide, a urea, or an amine; R² is each independently a hydrogen or a C₁ to about a C₆ aliphatic group which may be the same or different, branched or straight chained, saturated or unsaturated; and X is a C₂ to C₆ tether, which may substituted or unsubstituted, saturated or unsaturated, or linear or branched. In one embodiment, R² is methyl and R¹ is an alkyl group comprising about 14 to about 20 carbon atoms. Preferably, R¹ comprises a straight chain alkyl group having 18 carbon atoms. R¹ may comprise an alkylamidopropyl group.

In one embodiment, the associative thickener polymer comprises a hydrophilic group which bridges at least two hydrophobic groups. The hydrophobic group may correspond to the R¹ group of the primary surfactant.

In another aspect, the invention may comprise a method of acid stimulation of a subterranean formation, comprising the step of pumping into a wellbore an acidizing fluid comprising a composition as described herein. The method may comprise a matrix acidization stimulation or a fracture acidization stimulation.

In another aspect, the invention may comprise a method of acid stimulation of a subterranean formation, comprising the step of pumping into a wellbore an acidizing fluid comprising a sulfobetaine surfactant, a polymeric associative thickener, and a short chain alcohol, wherein the acidizing fluid comprises sufficient acid so as to be non-viscous when pumped into a wellbore and becomes viscous as acid is consumed by reaction with formation components and pH of the fluid rises.

In another aspect, the invention may comprise a method of acid stimulation of a subterranean formation, comprising the step of pumping into a wellbore an acidizing fluid comprising a sulfobetaine surfactant which forms non-elongate micelles, a polymeric associative thickener, and a short chain alcohol, wherein the fluid has a first viscosity at a pH of less than about 0.1, a second viscosity greater than the first viscosity at a pH of between about 0.1 to about 1.0, and a third viscosity intermediate to the first viscosity and the second viscosity at a pH above about 5.0.

### BRIEF DESCRIPTION OF THE DRAWINGS

FIG. 1 is a graph showing the effect of acid spending and impact of secondary surfactant on viscosity of self-diverted acid (SDA) fluids (as described in Example 14) in 15% HCl spent with CaCO₃.

FIG. 2 is a graph showing the effect of temperature on viscosity of SDA fluids (as described in Example 15) in 15% HCl spent with CaCO₃.

FIG. 3 is a graph showing the corrosion rate of QT-800 electrode in 15 wt % HCl SDA blend (no corrosion inhibitor) (as described in Example 16) over 6 hrs at 60° C.

FIG. 4 is a graph showing viscosity of an SDA fluid in the presence of a varied amount of ferric ions (as described in Example 19).

### DETAILED DESCRIPTION OF PREFERRED EMBODIMENTS

The present invention relates to a method and a composition for acid stimulating a formation bearing hydrocarbons. Any term or expression not expressly defined herein shall have its commonly accepted definition understood by those skilled in the art.

Throughout this specification, when a certain numerical range is expressed, even if only a few specific data points are explicitly identified or referred to within the range, or even when no data points are referred to within the range, it shall be understood that the end points and any and all data points within the range are to be considered to have been specified, and that the inventors have possession of the entire range and all points within the range. Furthermore, when the term “about” is used, it shall include the stated value itself, and a range which is 10% above and below the stated value, or a range which allows for reasonable margins of error of the experimental or analytical measurement capabilities of those skilled in the art.

Acid stimulation of formations is well known to those skilled in the art. Typically, a strong acid such as hydrochloric acid or hydrofluoric acid, or mixtures of strong acids are used. The reaction of strong acids with carbonate minerals such as limestone and dolomite is rapid, with the reaction rate limited only by the amount of unspent acid reaching the mineral surface. This reaction has been exploited to enhance hydrocarbon production from carbonate reservoirs by treating them with acid to create “wormholes” that increase the permeability of the surrounding formation. The challenge lies in designing a well treatment that achieves adequate stimulation of all formation surfaces, as conventional acidizing treatments result in preferential flow of acid to areas of already high permeability, with little stimulation of damaged or low permeability zones.

In general terms, the invention comprises a self diverting acid (SDA) stimulating fluid which includes an aqueous medium comprising an acid, a primary surfactant, an associative thickener, and a short chain alcohol. In one embodiment, the fluid may further comprise a secondary surfactant, which may have beneficial effect. In embodiments, the fluid has a low viscosity, essentially that of the aqueous medium itself, initially when large amounts of acid are present, and the pH is about 0. In one embodiment, the viscosity of the fluid increases as the acid is consumed by reaction with the formation, and the pH increases, preferably between a pH of about 0.1 and about 1.0. In one embodiment, the fluid becomes less viscous as the acid becomes completely consumed, and the pH rises above about 5.

Acid Component

In one embodiment, the aqueous medium comprises mineral acids. These may include hydrochloric acid, nitric acid, phosphoric acid, or hydrofluoric acid. For treating carbonate formations, hydrochloric acid is known to be particularly useful. The acid may be present in the SDA fluid in an amount of from about 0.3% to about 28% by weight of the SDA fluid, more typically the acid is used in an amount of from about 15% to about 20% by weight of the SDA fluid.

Primary Surfactant

In one embodiment, the primary surfactants of the present invention comprise sulfobetaine surfactants which form non-elongate or reasonably spherical micelles in aqueous solutions at a pH of above about 0, which are reasonably stable to hydrolysis by acid, particularly at elevated temperatures, and which substantially remain in aqueous solution in the presence of high salt concentrations. Such sulfobetaine surfactants may be cationic in very strong acid solutions due to protonation of the sulfonate group, but are zwitterionic otherwise. As used herein, a micelle is non-elongate if, on average, it has a length to width ratio of less than about 2.0.

As used herein, a “sulfobetaine” surfactant is a surfactant having a terminal sulfonate group and an ammonium group, which are separated by a tether, and a hydrophobic chain. Sulfobetaines are generally described in Weers et al., “Effect of the Intramolecular Charge Separation Distance on the Solution Properties of Betaines and Sulfobetaines” Langmuir, 7, 854 (1991), the entire contents of which are incorporated herein by reference, where permitted.

The sulfobetaine surfactants of the present invention form substantially non-elongated micelles at a pH of about 7.0 or less. Sulfobetaines which form viscoelastic worm-like or rod-like micelles are not included within the scope of this invention. Without restriction to a theory, it is believed that the larger head group area of sulfobetaine surfactants limits the close approach of head groups required for rod-like micelle formation, particularly those with a longer tether (3 or more carbon atoms), and therefore long tether sulfobetaine surfactants are restricted to spherical or nearly spherical micelle formation.

In one embodiment, the sulfobetaine surfactants do not significantly viscosify a solution without the addition of other components.

In one embodiment, the sulfobetaine has the formula:

R¹—N⁺(R²)₂—X—SO₃⁻

in which: R¹ is a hydrophobic group having between about 10 to 24 carbon atoms, and may be branched or straight chained, saturated or unsaturated, and may include a carbonyl, an amide, a retroamide, an imide, a urea, or an amine; R² is each independently a hydrogen or a C₁ to about a C₆ aliphatic group which may be the same as or different than the other R², branched or straight chained, saturated or unsaturated; and X is a tether comprising at least two carbon atoms, and no more than 6 carbon atoms, which may be either substituted or unsubstituted, and either saturated or unsaturated, and either linear or branched.

In one embodiment, R¹ is a straight chained group having between about 14 to about 22 carbon atoms; and at least one of R² is a methyl or ethyl group.

In one preferred embodiment, R¹ is a straight chained saturated group having 15 to 20 carbon atoms, R² are both methyl, and X is a tether having between 3 to 5 carbon atoms, and most preferably 3 carbon atoms.

In one embodiment, the sulfobetaine comprises 3-(N,N-Dimethylstearylammonio)propanesulfonate, (CAS Number 13177-41-8) referred to herein as “SB3-18 Surfactant”, a compound having the formula:

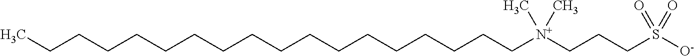 [SMILES: CCCCCCCCCCCCCCCCCC[N+](C)(C)CCCS(=O)(=O)[O-]]

In one embodiment, the R¹ group may be derived from tallow, which comprises a number of different saturated and unsaturated fatty acids. Tallow primarily comprises triacylglycerols with larger amounts of oleic acid, palmitic acid, and stearic acid, with smaller amounts of myristic acid, palmitoleic acid, linoleic acid, and linolenic acid. The resulting surfactant derived from tallow will be a mixture of sulfobetaines, having different R¹ groups corresponding to the fatty acids found in the source tallow.

In one embodiment, the sulfobetaine comprises Tallow Amidopropyl Hydroxysultaine (TAHS), CAS Number 70131-57-6, a compound having the formula:

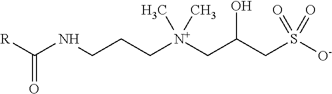

where R is a carbon chain derived from tallow. TAHS has an amidopropyl hydrophobic tail derived from soft tallow, which typically is composed of ˜45% unsaturated hydrocarbon chains (mainly oleyl) and ˜55% saturated carbon chains (C₁₄₋₁₈), and a hydroxypropyl tether.

The primary surfactant of the present invention may comprise a single compound, or a mixture of compounds. If the surfactant has proportionately more hydrophobic components, such as longer R¹ chain lengths, it may be less soluble in the aqueous acid solution. In such cases, a secondary surfactant may improve the solubility of the primary surfactant, and/or the performance of the SDA fluid.

Secondary Surfactant

In one embodiment, the fluid may comprise a secondary surfactant which may lead to more desirable SDA performance. For example, the use of a secondary surfactant may result in earlier viscosity onset in the acid spending process, and/or a higher maximum viscosity achieved for similar chemical loadings. Like the primary surfactant, the secondary surfactant may also form non-elongate micelles in aqueous solution. The secondary surfactant may comprise a single compound, or a mixture of compounds.

In one embodiment, the secondary surfactant is a non-ionic surfactant having the general formula:

HO—Y—R³

in which: R³ is selected from linear or branched C₁₆-C₂₂-alkyl, C₁₆-C₂₂-alkenyl, C₁₆-C₂₂-alkynyl, (C₁₅-C₂₁-alkyl)carbonyl, (C₁₅-C₂₁-alkenyl)carbonyl and (C₁₅-C₂₁-alkynyl)carbonyl; and Y is a group consisting of 1 to 20 alkyleneoxy units.

In one embodiment, the secondary surfactant may be a surfactant pre-cursor which is hydrolyzed to a non-ionic surfactant by the strong acid environment of the SDA fluid. Thus, the secondary surfactant may comprise an ethoxylated C₁ alcohol phosphate or sulfate ester, where n=15 to 22, which comprises a P—O—C linkage or an S—O—C linkage, such as the compounds of formulae I.a, I.b or Lc, or salts thereof, or mixtures thereof:

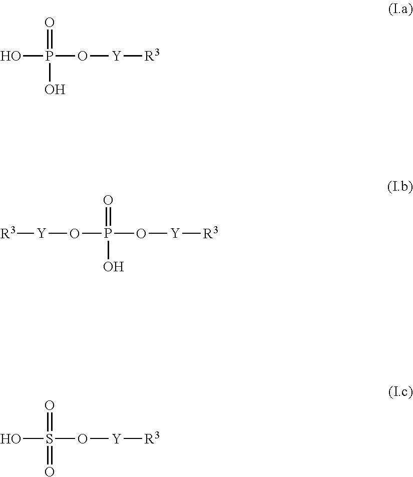

in which R³ and Y are as above.

Further examples of suitable anionic secondary surfactants are described in U.S. Pat. No. 8,193,127, the contents of which are hereby incorporated by reference, where permitted.

In one embodiment, the secondary surfactant is an anionic surfactant comprising a compound corresponding to formula I.a or I.b, or salts thereof, or a mixture thereof, where R³ is selected from linear or branched C₁₆-C₂₂-alkyl or C₁₆-C₂₂-alkenyl, and Y is a group consisting of approximately 4 alkylenoxy units. The P—O—C linkage of ethoxylated phosphate esters is known to be subject to hydrolysis under acidic conditions, such as described in the present invention. Upon addition of the phosphate ester secondary surfactant to an acidic solution with pH <2, the phosphate ester secondary surfactant is assumed to undergo hydrolysis to form the corresponding ethoxylated alcohol H—O—Y—R³ and phosphoric acid.

Associative Thickener Polymer

The associative thickener comprises a polymer which has at least one hydrophobic group and at least one hydrophilic group. The polymers are preferably water-soluble and comprise a hydrophilic group (a), to which at least one hydrophobic R⁴ group is bonded, and preferably selected from compounds comprising at least two hydrophobic R⁴ groups, which are bonded to one another via the hydrophilic group (a) which bridges the two hydrophobic R⁴ groups. As a result, the polymers are simultaneously hydrophobic and hydrophilic. The hydrophobic R⁴ groups preferably have a structure which is similar to or corresponds to the hydrophobic R¹ groups of the primary surfactant component and/or the R³ groups of the secondary surfactant. The rheological properties of the fluid of the present invention are determined by interactions of the associative thickener polymers, specifically of their hydrophobic R⁴ groups, with the micelles of the primary surfactant, and secondary surfactants if present. These interactions are believed to be physical hydrophobic-hydrophobic interactions, thus forming overlapping networks.

Some suitable examples of the associative thickener polymer are described in U.S. Pat. No. 8,193,127.

In one embodiment, the hydrophobic R⁴ groups of the polymers comprise, on average, preferably at least 14 and especially at least 16 carbon atoms. The upper limit of the carbon atom number is generally uncritical and is, for example, up to 100, preferably up to 50, and even more preferably up to 35. More preferably, less than 10% of the hydrophobic R⁴ groups present in the polymers comprise less than 15 and more than 23 carbon atoms.

Preferably, on average, less than 20% and especially less than 5% of the R⁴ groups present have a carbon-carbon double bond.

In one embodiment, the hydrophobic R⁴ groups are preferably selected from linear and branched C₁₂-C₂₂-alkyl, C₁₂-C₂₂-alkenyl or 2-hydroxy(C₁₂-C₂₂-alk-1-yl).

The R⁴ groups of the polymers have, on average, preferably at most one, more preferably at most 0.5, and even more preferably at most 0.2 branch. In particular, the R⁴ groups are each independently selected from palmityl, stearyl, oleyl, linoleyl, arachidyl, gadoleyl, behenyl, erucyl, isostearyl, 2-hexyldecyl, 2-heptyldecyl, 2 heptylundecyl, 2-octyldodecyl and 2-hydroxypalmityl, 2-hydroxystearyl, 2-hydroxyoleyl, 2-hydroxylinoleyl, 2-hydroxyarachidyl, 2-hydroxygadoleyl, 2-hydroxybehenyl, 2-hydroxyerucyl and 2-hydroxyisostearyl. Preferably at least 70% of the R⁴ groups present in the polymers are unbranched.

In a specific embodiment, the hydrophilic groups (α) comprise at least two hydrophilic units (β). The hydrophilic units (β) may have identical or different definitions. Identical hydrophilic units (β) are always bonded to one another via a bridging group (γ). Different hydrophilic units (β) may be bonded directly to one another or via a bridging group (γ).

In a preferred embodiment, the bridging hydrophilic group (α) comprises, as hydrophilic units (β), polyether units and/or polyvinyl alcohol units. More preferably, the bridging hydrophilic group (α) consists of polyether units at least to an extent of 90%.

In a specific embodiment of the present invention, the hydrophilic units (β) of the polymers are at least partly selected from polyether units of the general formula (II):

[(O—(CH₂)₂)_{y1}(O—CH(CH₃)CH₂)_{y2}]— (II)

in which the sequence of the alkyleneoxy units is as desired and y¹ and y² are each independently an integer from 0 to 300, where the sum of y¹ and y² is from 10 to 300.

The sum of y¹ and y² denotes the number of alkyleneoxy units of this polyether chain and in one embodiment, has, averaged over all polyether units of the formula (II) present, preferably a value in the range from 20 to 200, more preferably from 30 to 150.

The ratio of y¹ to y² expresses the ratio of ethyleneoxy to propyleneoxy units. In one embodiment, averaged over the polyether chain of the general formula (II) present, the ratio of y¹ to y² is preferably at least 2:1, and more preferably at least 5:1.

In a specific embodiment of the present invention, the polyether chain of the formula (II) consists exclusively of ethyleneoxy units. In this embodiment, y² is 0.

Various hydrophilic polyether units are preferably bonded to one another without bridging groups (γ). These include, for example, EO/PO block copolymer units.

In a further specific embodiment of the present invention, the hydrophilic groups (α) are composed of hydrophilic units (β) which are bonded to one another via bridging groups (γ), with the bridging groups (γ) being structurally different from the repeat units of which the hydrophilic units (β) are composed.

The bridging groups (γ) between the hydrophilic units (β) of the polymer in the fracturing fluid composition are preferably selected from m-valent, preferably 2- to 4-valent, groups containing from 1 to 10 bridging atoms between the flanking bonds, where the co-valent group has structures which are selected from —OC(═O)—, —C(═O)OC(═O)—, —OC(═O)O—, —OC(═O)NH—, —NC(═O)NH—, alkylene, alkenylene, arylene, heterocyclylene, cycloalkylene, where alkylene and alkenylene may be interrupted once or more than once by oxygen, sulfur, —NH— and —N(C₁-C₁₀-alkyl)-, arylene, heterocyclylene and cycloalkylene may be mono- or polysubstituted by C₁-C₄-alkyl, and m is an integer in the range from 2 to 4. The bridging groups (γ) preferably have —OC(═O)NH— as terminal structural units.

In this context, the term “m-valent group” means that the bridging group (γ) is capable of forming m chemical bonds, where m is an integer and is preferably 2, 3 or 4.

When alkylene or alkenylene is interrupted by one or more, for example 1, 2, 3, 4, 5, 6, 7 or 8 nonadjacent groups which are each independently selected from oxygen, sulfur, —NH— and N(C₁-C₁₀-alkyl)-, the termini of the alkylene or alkenylene group is formed by carbon atoms.

When the m-valent group (γ) has a valency greater than 2, branching of the polymer is enabled. In this case, the polymer may also comprise more than two hydrophobic R⁴ groups.

The polymer preferably comprises from two to six, and more preferably from two to four hydrophobic R⁴ groups.

The preferred range for the molecular weight of the polymer arises through multiplication of the number of hydrophobic R⁴ groups present with a value of from 1500 g/mol to 8000 g/mol.

The polymers preferably have, on average, a molecular weight in the range from 3000 g/mol to 50000 g/mol, more preferably in the range from 5000 g/mol to 30000 g/mol.

Polymers used in accordance with the invention can, for example, be provided by reacting polyisocyanates, polyols, polyamines, polycarboxylic acids with a suitable alkoxylated alcohol, for example an alkoxylated alcohol of the formula R⁴-[(O—(CH₂)₂)_{y1}(O—CH(CH₃)CH₂)_{y2}]-OH or mixtures of these alkoxylated alcohols. These alcohols are provided especially by reacting natural or synthetic mixtures of fatty alcohols and oxo alcohols with ethylene oxide and/or propylene oxide. This typically affords mixtures of alcohols with a different number of alkyleneoxy units, which can be used as such. The polymers used in accordance with the invention can likewise be provided by reacting compounds which comprise at least two different functional groups with the aforementioned alcohols. The polymers are preferably provided starting from polyisocyanates or polyols (diols, triols, and higher polyhydric polyols).

Suitable polyisocyanates, especially diisocyanates and triisocyanates, for providing polymers are the aliphatic, cycloaliphatic, araliphatic and aromatic di- or polyisocyanates mentioned below by way of example. These preferably include 4,4′-diphenylmethane diisocyanate, the mixtures of monomeric diphenylmethanediisocyanates and oligomeric diphenylmethanediisocyanates (polymer-MDI), tetramethylenediisocyanate, tetramethylenediisocyanate trimers, hexamethylenediisocyanate, hexamethylenediisocyanate trimers, isophoronediisocyanate trimer, 4,4′-methylenebis(cyclohexyl) diisocyanate, xylylenediisocyanate, tetramethylxylylenediisocyanate, dodecyldiisocyanate, lysine alkyl ester diisocyanate where alkyl is C₁-C₁₀-alkyl, 1,4-diisocyanatocyclohexane or 4-isocyanatomethyl-1,8-octamethylene diisocyanate, and more preferably hexamethylenediisocyanate and 4,4′-diphenylmethane diisocyanate.

Suitable diols for providing the polymers are straight-chain and branched, aliphatic and cycloaliphatic alcohols having generally from about 1 to 30, preferably from about 2 to 20 carbon atoms. These include 1,2-ethanediol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,5-hexanediol, 1,2-heptanediol, 1,7-heptanediol, 1,2-octanediol, 1,8-octanediol, 1,2-nonanediol, 1,9-nonanediol, 1,2-decanediol, 1,10-decanediol, 1,12-dodecanediol, 2-methyl-1,3-propanediol, 2-methyl-2-butyl-1,3-propanediol, 2,2-dimethyl-1,3-propanediol, 2,2-dimethyl-1,4-butanediol, pinacol, 2-ethyl-2-butyl-1,3-propanediol, diethylene glycol, triethylene glycol, dipropylene glycol, tripropylene glycol, polyalkylene glycols, cyclopentanediols, cyclohexanediols, etc.

Suitable triols for providing the polymers are, for example, glycerol, butane-1,2,4-triol, n-pentane-1,2,5-triol, n-pentane-1,3,5-triol, n-hexane-1,2,6-triol, n-hexane-1,2,5-triol, trimethylolpropane, or trimethylolbutane. Suitable triols are also the esters of hydroxycarboxylic acids with trihydric alcohols. They are preferably triglycerides of hydroxycarboxylic acids, for example lactic acid, hydroxystearic acid and ricinoleic acid. Also suitable are naturally occurring mixtures which comprise hydroxycarboxylic acid triglycerides, especially castor oil. Preferred triols are glycerol and trimethylolpropane.

Suitable higher polyhydric polyols for providing polymers are, for example, sugar alcohols and derivatives thereof, such as erythritol, pentaerythritol, dipentaerythritol, threitol, inositol and sorbitol. Also suitable are reaction products of the polyols with alkylene oxides, such as ethylene oxide and/or propylene oxide. It is also possible to use higher molecular weight polyols with a number-average molecular weight in the range from about 400 g/mol to 6000 g/mol, preferably from 500 g/mol to 4000 g/mol. These include, for example, polyesterols based on aliphatic, cycloaliphatic and/or aromatic di-, tri- and/or polycarboxylic acids with di-, tri- and/or polyols, and also the polyesterols based on lactone. These further include polyetherols which are obtainable, for example, by polymerizing cyclic ethers or by reacting alkylene oxides with a starter molecule. These further also include customary polycarbonates with terminal hydroxyl groups which are known to those skilled in the art and are obtainable by reacting the above-described diols or else bisphenols, such as bisphenol A, with phosgene or carbonic esters. Also suitable are α,ω-polyamidols, α,ω-polymethyl (meth)acrylatediols and/or α,ω-polybutyl (meth)acrylatediols, for example MD-1000 and BD-9000 from Goldschmidt™.

Suitable dicarboxylic acids for providing polymers are, for example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid, phthalic acid, isophthalic acid, terephthalic acid and mixtures thereof.

The abovementioned dicarboxylic acids may also be substituted. Suitable substituted dicarboxylic acids may have one or more radicals which are preferably selected from alkyl, cycloalkyl and aryl, as defined at the outset. Suitable substituted dicarboxylic acids are, for example, 2-methylmalonic acid, 2-ethylmalonic acid, 2-phenylmalonic acid, 2-methylsuccinic acid, 2-ethylsuccinic acid, 2-phenylsuccinic acid, itaconic acid, or 3,3-dimethylglutaric acid, etc.

Dicarboxylic acids can be used either as such or in the form of derivatives. Suitable derivatives are anhydrides and their oligomers and polymers, mono- and diesters, preferably mono- and dialkyl esters, and acid halides, preferably chlorides. Suitable esters are mono- or dimethyl esters, mono- or diethyl esters, and also mono- and diesters of higher alcohols, for example n-propanol, iso-propanol, n-butanol, iso-butanol, tert-butanol, n-pentanol, n-hexanol, etc, and also mono- and vinyl esters and mixed esters, preferably methyl ethyl esters.

Preferred polycarboxylic acids for providing the polymers are succinic acid, glutaric acid, adipic acid, phthalic acid, isophthalic acid, terephthalic acid or their mono- or dimethyl esters. Particular preference is given to adipic acid.

Suitable polyamines are, for example, ethylenediamine, propylenediamine, diethylenetriamine, triethylenetetramine, tetraethylenepentamine, polyethyleneimine, 1,3-propanediamine, N,N-bis(aminopropyl)amine, N,N,N-tris(aminoethyl)amine, N,N,N′,N′-tetrakis(aminoethyl)ethylenediamine, N,N,N′,N″,N″-pentakis(aminoethyl)-diethylenetriamine, neopentanediamine, hexamethylenediarnine, octamethylenediamine or isophoronediamine.

Further compounds suitable for providing the polymers are compounds which comprise at least two different functional groups, for example ethanolamine, N-methylethanolamine, propanolamine, hydroxyacetic acid, lactic acid, glutamic acid, or aspartic acid.

In a particularly preferred embodiment, the polymer is provided proceeding from (a) C₁₄-C₂₂ fatty alcohol ethoxylates and mixtures thereof (b) polyethylene glycol, EO-PO copolymers, trimethylolpropaneethoxylates/trimethylolpropanepropoxylates, glycerylethoxylates/propoxylates and mixtures thereof, and (c) hexamethylenediisocyanates.

In a further particularly preferred embodiment, the polymer is provided proceeding from (a) polyethylene glycol, EO-PO copolymers, trimethylolpropaneethoxylates/trimethylolpropanepropoxylates, glycerylethoxylates/propoxylates and mixtures thereof, and (b) 1,2-epoxy-C₁₄-C₂₂-alkanes and mixtures thereof.

In one specific embodiment, the polymer comprises a reaction mixture comprising the polymers obtained from the reaction of C₁₆-C₁₈-alkyl-[(O—(CH₂)₂)₁₄₀]-OH (78% by wt.), PEG 12000 (20% by wt) and hexamethylenediisocyanate (2% by wt.), in a mixture of 1,2-propanediol, iso-propanol and water.

In one embodiment, the associative thickener is applied at a concentration below the polymer overlap concentration, c*, preferably at least 0.1 c*, and more preferably within a range of about 0.2 to 0.7 c*. The “polymer overlap concentration” is obtained by plotting the log of the zero shear viscosity of the polymer fluid as a function of the log of its concentration (without a surfactant component), as defined in United States Patent Application No. 2005/0107503, the contents of which are incorporated herein by reference, where permitted. The curve will define three distinct slopes having two intersecting points, each referred to as a break point. The more dilute break point is the overlap concentration of the polymer, while the less dilute break point is the entanglement concentration.

Short Chain Alcohol

In one embodiment, the short chain alcohol comprises a primary or secondary monoalcohol having between about 5 carbon atoms to about 10 carbon atoms. Conveniently, the alcohol may comprise a hexanol or an octanol, such as 2-ethyl-1-hexanol, n-hexanol, or n-octanol.

SDA Fluid Composition and Properties

In one embodiment, when the components of the stimulating fluid are combined the resulting fluid has a viscosity greater than any of its individual components.

In one embodiment, the resulting viscous fluid is not viscoelastic. The property of viscoelasticity in general is well known and reference is made to the following references: S. Graysholt, “Viscoelasticity in highly dilute aqueous solutions of pure cationic detergents”, Journal of Coll. And Interface Sci., 57 (3), 575 (1976); Hoffinann et al., “Influence of Ionic Surfactants on the Viscoelastic Properties of Zwitterionic Surfactant Solutions”, Langmuir, 8, 2140 (1992); and Hoffinann et al., “The Rheological Behaviour of Different Viscoelastic Surfactant Solutions”, Tenside Surf. Det., 31, 389 (1994). Of the test methods specified by these references to determine whether a liquid possesses viscoelastic properties, one test which has been found to be useful in determining the viscoelasticity of an aqueous solution consists of swirling the solution and visually observing whether the bubbles created by the swirling recoil after the swirling is stopped. Any recoil of the bubbles indicates viscoelasticity. Another useful test is to measure the storage modulus (G′) and the loss modulus (G″) at a given temperature. If G′>G″ at some point or over some range of points below about 10 rad/sec, typically between about 0.001 to about 10 rad/sec, more typically between about 0.1 and about 10 rad/sec, at a given temperature and if G′>10⁻² Pascals, preferably 10⁻¹ Pascals, the fluid is typically considered viscoelastic at that temperature. Rheological measurements such as G′ and G″ are discussed more fully in “Rheological Measurements”, Encyclopedia of Chemical Technology, vol. 21, pp. 347-372, (John Wiley & Sons, Inc., N.Y., N.Y., 1997, 4th ed.). These references are expressly incorporated herein by reference, where perinitted.

The total amount of “active material” (the combined primary surfactant, secondary surfactant, if present, and associative thickener) may be varied to achieve a desired viscosity or other properties of the fluid, and may range from about 0.1 wt % to about 30 wt % of the fluid. In one embodiment, the active material may comprise from about 0.2 wt % to about 2.0 wt % of the fluid. In one specific embodiment, the active material may comprise about 0.7 wt % of the fluid. In one embodiment, the fluid may comprise about 0.55 wt % of primary surfactant.

In one embodiment, the ratio of total surfactant (primary surfactant and secondary surfactant) to associative thickener is preferably less than about 10.0, and preferably less than about 6.0, on a weight basis. In one embodiment, this ratio is about 5.0 to about 5.5.

In one embodiment, the total surfactant to short-chain alcohol molar ratio is less than about 8.0, preferably less than about 5.0, and most preferably less than about 3.0.

Use of the Acidizing Fluid Composition

In use, the SDA treatment fluid, which may be a matrix acidizing fluid or an acid fracturing fluid, may be formulated at the surface. The primary surfactant, acid, alcohol, associative thickener, and secondary surfactant, if present, and other additives may be mixed with an aqueous fluid, such as fresh water, sea water, brine. Functional additives may include a defoamer, a corrosion inhibitor, and/or an iron control agent, all of which are well known in the art and commercially available. The treatment fluid is then introduced into the wellbore of the formation to facilitate treatment. Matrix acidizing and fracture acidizing using the treatment fluids are typically undertaken to provide improved flow paths for the production of hydrocarbons, but may also be used for other purposes known to those skilled in the art, such as for injection wells.

In one embodiment, the SDA treatment fluid may be foamed or energized using nitrogen or carbon dioxide, as is well known in the art.

The acid treatment fluid may be formulated from premixed concentrate solutions of its components. Such concentrates may use a solvent such as a lower alkyl alcohol to solubilize the surfactant and/or associative thickener. In one embodiment, iso-propanol is a convenient and cost-effective choice. Alternatively, the pH or the salt concentration of the aqueous medium may be adjusted to assist in the solubilization of the primary surfactant in the concentrate.

### Examples

The following examples are given to exemplify embodiments of the invention, and not to limit the claimed invention. As will be apparent to those skilled in the art, various modifications, adaptations and variations of the specific disclosure herein can be made without departing from the scope of the invention claimed herein. The various features and elements of the described invention may be combined in a manner different from the combinations described herein, without departing from the scope of the invention as defined in the claims.

In the following examples, the following concentrate solutions were used (all percentages are approximate % by weight):

SB3-18 Surfactant Solution
33.3% SB3-18 Surfactant
33.3% iso-Propanol
33.3% Deionized Water

Tallow Amidopropyl Hydroxysultaine (TAHS) Surfactant Solution
43% Tallow Amidopropyl Hydroxysultaine (TAHS)
Balance iso-propanol and deionized water

AT Premix 1—Associative Thickener Solution
50% Associative Thickener Concentrate (50 wt % active polymer in water/iso-propanol)
50% iso-Propanol

AT Premix 2—Associative Thickener without n-Octanol
25.1% Associative Thickener Concentrate (50 wt % active polymer)
6.6% SB3-18 Surfactant (solid)
14.6% iso-Propanol
53.7% Deionized Water

AT Premix 3—Associative Thickener with n-Octanol
25.1% Associative Thickener Concentrate (50 wt % active polymer)
6.6% SB3-18 Surfactant (solid)
5.0% n-Octanol
9.6% iso-Propanol
53.7% Deionized Water

AT Premix 4—Associative Thickener with n-Octanol and Secondary Surfactant
25.1% Associative Thickener Concentrate (50 wt % active polymer)
26.4% Secondary surfactant (a mixture of surfactants I.a and I.b in water/iso-propanol, 25 wt % active material)
5.0% n-Octanol
9.6% iso-Propanol
33.9% Deionized Water

AT Premix 5—Associative Thickener with 0% n-Octanol
25.1% Associative Thickener Concentrate (50 wt % active polymer)
6.6% SB3-18 Surfactant (solid)
0.0% n-Octanol
9.6% iso-Propanol
58.7% Deionized Water

AT Premix 6—Associative Thickener with 2.5% n-Octanol
25.1% Associative Thickener Concentrate (50 wt % active polymer)
6.6% SB3-18 Surfactant (solid)
2.5% n-Octanol
9.6% iso-Propanol
56.2% Deionized Water

AT Premix 7—Associative Thickener with 7.5% n-Octanol
25.1% Associative Thickener Concentrate (50 wt % active polymer)
6.6% SB3-18 Surfactant (solid)
7.5% n-Octanol
9.6% iso-Propanol
51.2% Deionized Water

AT Premix 8—Associative Thickener with 10% n-Octanol
25.1% Associative Thickener Concentrate (50 wt % active polymer)
6.6% SB3-18 Surfactant (solid)
10.0% n-Octanol
9.6% . iso-Propanol
48.7% Deionized Water

AT Premix 9—Associative Thickener with 12% n-Octanol
25.1% Associative Thickener Concentrate (50 wt % active polymer)
6.6% SB3-18 Surfactant (solid)
12.0% n-Octanol
9.6% iso-Propanol
46.7% Deionized Water

AT Premix 10—Associative Thickener with 15% n-Octanol
25.1% Associative Thickener Concentrate (50 wt % active polymer)
6.6% SB3-18 Surfactant (solid)
15.0% n-Octanol
9.6% iso-Propanol
43.7% Deionized Water

AT Premix 11—Associative Thickener with 17.5% n-Octanol
25.1% Associative Thickener Concentrate (50 wt % active polymer)
6.6% SB3-18 Surfactant (solid)
17.5% n-Octanol
9.6% iso-Propanol
41.2% Deionized Water

AT Premix 12—Associative Thickener with 20% n-Octanol
25.1% Associative Thickener Concentrate (50 wt % active polymer)
6.6% SB3-18 Surfactant (solid)
20.0% n-Octanol
9.6% iso-Propanol
38.7% Deionized Water

AT Premix 13—Associative Thickener with 2-Ethyl-1-Hexanol and Secondary Surfactant (2 EO Oleyl Alcohol)
25.1% Associative Thickener Concentrate (50 wt % active polymer)
6.6% 2 EO Oleyl Alcohol (90-100% active surfactant)
5.0% 2-Ethyl-1-hexanol
9.6% iso-Propanol
53.7% Deionized Water

AT Premix 14—Associative Thickener with 2-Ethyl-1-Hexanol
25.1% Associative Thickener Concentrate (50 wt % active polymer)
6.6% SB3-18 Surfactant (solid)
5.0% 2-Ethyl-1-hexanol
9.6% iso-Propanol
53.7% Deionized Water

Acid spending was carried out either in situ, by adding powdered calcium carbonate to an SDA fluid prepared in aqueous hydrochloric acid, or prior to SDA preparation. Pre-spent acid solutions were made by adding known quantities of powdered calcium carbonate to 15% HCl solutions and allowing the neutralization reaction to finish before adding the SDA additives. Spent acid strength was calculated from the reaction stoichiometry based on the initial acid concentration and volume and the mass of CaCO₃ added; in many cases the spent acid solution was also titrated with 1 M NaOH to a phenolphthalein endpoint to confirm the resulting acid concentration.

### Example 1

### Viscosity of Spent Acid Solutions Containing Surfactant Only

In this example, 200 mL of 15 wt % HCl (4.4 M HCl) was placed in a 400 mL plastic beaker and the contents mixed at 1000 rpm on an overhead stirrer equipped with a three-bladed propeller assembly. SB3-18 Surfactant Solution (3.6 mL, 18 L/m³) was added to the beaker and mixed for 120 seconds. The viscosity of the solution was measured on an OFITE™ 900 model viscometer at ambient temperature. A pre-weighed portion of calcium carbonate powder (CaCO₃, ACS reagent grade) was added to the solution and allowed to react until most of the foam had dissipated, and then the viscosity of the solution was re-measured. The calcium carbonate spending process was repeated until the acid was almost entirely spent. Viscosity data is shown in Table 1.1.

TABLE 1.1
Effect of acid spending with CaCO₃ on the
viscosity of solutions containing 0.55 wt %* SB3-18

| | Viscosity of | | |
|---|---|---|---|
| wt % HCl | solution in cP at | | |
| remaining | 511 s⁻¹ | 170 s⁻¹ | 100 s⁻¹ |
| 15.0** | 1.1 | 0.9 | 0.0 |
| 7.7 | 1.5 | 0.5 | 0.2 |
| 3.9 | 1.7 | 0.0 | 0.0 |
| 1.8 | 1.0 | 1.8 | 2.6 |
| 1.1 | 1.4 | 1.5 | 1.6 |
| 0.4 | 2.0 | 2.2 | 3.1 |

*18 L/m³ of a 33.3 wt % solution of SB3-18
**Initial concentration of live acid in solution before reaction with CaCO₃

To minimize the foaming observed on reaction of calcium carbonate with surfactant solutions in hydrochloric acid, 15% HCl solutions were reacted with known amounts of CaCO₃ until predetermined acid concentrations remained. For each spent acid concentration prepared, 200 mL of the pre-spent hydrochloric acid solution was placed in a 400 mL plastic beaker and the contents mixed at 1000 rpm on an overhead stirrer equipped with a three-bladed propeller assembly. TAHS Surfactant Solution (either 3.0 mL, 15 L/m³, or 6.0 mL, 30 L/m³) was added to the beaker and mixed for 120 seconds. The viscosity of the solution was measured on an OFITE™ 900 model viscometer at ambient temperature. Viscosity data are shown in Tables 1.2 and 1.3.

TABLE 1.2
Effect of acid spending with CaCO₃ on the
viscosity of solutions containing 0.55 wt % TAHS

| | Viscosity of | | |
|---|---|---|---|
| wt % HCl | solution in cP at | | |
| remaining | 511 s⁻¹ | 170 s⁻¹ | 100 s⁻¹ |
| 15.0* | 1.3 | 0.0 | 0.0 |
| 7.7 | 1.4 | 0.0 | 0.0 |
| 3.7 | 1.9 | 0.0 | 0.0 |
| 1.9 | 1.8 | 0.3 | 0.0 |
| 1.3 | 1.4 | 0.5 | 0.2 |
| 0.6 | 1.8 | 0.7 | 0.1 |
| 0.0 | 1.7 | 1.0 | 1.1 |

*Initial concentration of live acid in solution before reaction with CaCO₃

TABLE 1.3
Effect of acid spending with CaCO₃ on the
viscosity of solutions containing 1.1 wt % TAHS

| | Viscosity of | | |
|---|---|---|---|
| wt % HCl | solution in cP at | | |
| remaining | 511 s⁻¹ | 170 s⁻¹ | 100 s⁻¹ |
| 15.0* | 1.1 | 0.0 | 0.0 |
| 7.7 | 1.2 | 0.2 | 0.0 |
| 3.7 | 1.2 | 0.0 | 0.0 |
| 1.9 | 1.3 | 0.9 | 0.0 |
| 1.3 | 1.8 | 1.0 | 1.0 |
| 0.6 | 1.8 | 0.6 | 0.0 |
| 0.0 | 2.2 | 0.7 | 0.8 |

*Initial concentration of live acid in solution before reaction with CaCO₃

As can be seen in Tables 1.1, 1.2 and 1.3, very little viscosity developed over a wide range of HCl concentration.

### Example 2

### Viscosity of Spent Acid Solutions Containing Associative Thickener Only

To minimize the foaming observed on reaction of calcium carbonate with surfactant solutions in hydrochloric acid, 15% HCl solutions were reacted with known amounts of CaCO₃ until predetermined acid concentrations remained. For each spent acid concentration prepared, 200 mL of the pre-spent hydrochloric acid solution was placed in a 400 mL plastic beaker and the contents mixed at 1000 rpm on an overhead stirrer equipped with a three-bladed propeller assembly. AT Premix 1 (0.8 mL, 4 L/m³) was added to the beaker and mixed for 120 seconds. The viscosity of the solution was measured on an OFITE™ 900 model viscometer at ambient temperature. Viscosity data is shown in Table 2.

TABLE 2
Effect of acid spending with CaCO₃ on the
viscosity of solutions containing 0.1 wt % AT Premix 1

| | Viscosity of | | |
|---|---|---|---|
| wt % HCl | solution in cP at | | |
| remaining | 511 s⁻¹ | 170 s⁻¹ | 100 s⁻¹ |
| 15.1* | 1.0 | 0.6 | 0.6 |
| 8.4 | 1.0 | 0.0 | 0.0 |
| 5.0 | 1.4 | 0.0 | 0.0 |
| 1.9 | 2.0 | 1.1 | 0.2 |
| 1.1 | 2.0 | 1.6 | 1.7 |
| 0.5 | 1.6 | 0.8 | 0.7 |
| 0.0 | 2.0 | 0.8 | 0.6 |

*Initial concentration of live acid in solution before reaction with CaCO₃

### Example 3

### Viscosity of Spent Acid Solutions Containing Surfactant and Associative Thickener

In this example, 200 mL of 15 wt % HCl (4.4 M HCl) was placed in a 400 mL plastic beaker and the contents mixed at 1000 rpm on an overhead stirrer equipped with a three-bladed propeller assembly. AT Premix 2 (1.6 mL, 8 L/m³) was added to the beaker by syringe and stirred at 1000 rpm for 30 seconds, after which 3.0 mL of SB3-18 Surfactant Solution (15 L/m³) was added to the beaker and mixed for an additional 90 seconds. The viscosity of the solution was measured on an OFITE™ 900 model viscometer at ambient temperature. A pre-weighed portion of calcium carbonate powder (CaCO₃, ACS reagent grade) was added to the solution and allowed to react until most of the foam had dissipated, and then the viscosity of the solution was re-measured. The calcium carbonate spending process was repeated until the acid was almost entirely spent. Viscosity data is shown in Table 3.

TABLE 3
Effect of acid spending with CaCO₃ on the viscosity of solutions
containing 0.55 wt % SB3-18 and 0.1 wt % AT Premix 2

| wt % HCl | Viscosity of solution in cP at | | |
|---|---|---|---|
| remaining | 511 s⁻¹ | 170 s⁻¹ | 100 s⁻¹ |
| 15.0* | 1.3 | 0.6 | 0.2 |
| 7.7 | 0.9 | 1.6 | 2.4 |
| 3.9 | 1.3 | 2.1 | 2.8 |
| 1.8 | 1.5 | 2.5 | 3.3 |
| 1.1 | 2.1 | 2.2 | 2.8 |
| 0.4 | 1.8 | 1.3 | 1.3 |
| 0.0 | 1.4 | 1.3 | 1.4 |

*Initial concentration of live acid in solution before reaction with CaCO₃

### Example 4

### Viscosity of Spent Acid Solutions Containing Surfactant, Associative Thickener, and a Short Chain Alcohol

In this example, 200 mL of 15 wt % HCl (4.4 M HCl) was placed in a 400 mL plastic beaker and the contents mixed at 1000 rpm on a Caframo™ overhead stirrer equipped with a three-bladed propeller assembly. AT Premix 3 (1.6 mL, 8 L/m³) was added to the beaker by syringe and stirred at 1000 rpm for 30 seconds, after which 3.0 mL of SB3-18 Surfactant Solution (15 L/m³) was added to the beaker and mixed for an additional 90 seconds. AT Premix 3 contains a short chain alcohol in the form of n-octanol. The viscosity of the solution was measured on an OFITE™ 900 model viscometer at ambient temperature. A pre-weighed portion of calcium carbonate powder (CaCO₃, ACS reagent grade) was added to the solution and allowed to react until most of the foam had dissipated, then the viscosity of the solution was re-measured. The calcium carbonate spending process was repeated until the acid was almost entirely spent. Viscosity data is shown in Table 4.

TABLE 4
Effect of acid spending with CaCO₃ on the viscosity
of solutions containing 0.55 wt % SB3-18, 0.1
wt % AT Premix 3, and 0.04 wt % n-octanol

| wt % HCl | Viscosity of solution in cP at | | |
|---|---|---|---|
| remaining | 511 s⁻¹ | 170 s⁻¹ | 100 s⁻¹ |
| 15.0* | 1.0 | 1.2 | 1.4 |
| 7.7 | 1.4 | 1.2 | 1.6 |
| 3.9 | 2.3 | 1.5 | 0.4 |
| 1.8 | 6.4 | 7.0 | 7.6 |
| 1.1 | 14.6 | 29.9 | 42.6 |
| 0.4 | 18.1 | 33.9 | 44.3 |
| 0.0 | 16.4 | 31.7 | 45.8 |

*Initial concentration of live acid in solution before reaction with CaCO₃

As may be seen by comparing Tables 3 and 4, the addition of a small amount of n-octanol allowed significant viscosity development as HCl was consumed in the fluid.

### Example 5

### Viscosity of Spent Acid Solutions Containing Surfactant, Associative Thickener, Short Chain Alcohol, and a Secondary Surfactant

To minimize the foaming observed on reaction of calcium carbonate with surfactant solutions in hydrochloric acid, 15% HCl solutions were reacted with known amounts of CaCO₃ until predetermined acid concentrations remained. For each spent acid concentration prepared, 200 mL of the pre-spent hydrochloric acid solution was placed in a 400 mL plastic beaker and the contents mixed at 1000 rpm on a Caframo™ overhead stirrer equipped with a three-bladed propeller assembly. AT Premix 4 (1.6 mL, 8 L/m³) was added to the beaker by syringe and stirred at 1000 rpm for 30 seconds, after which 3.0 mL of SB3-18 Surfactant Solution (15 L/m³) was added to the beaker and mixed for an additional 90 seconds. AT Premix 4 contains a secondary surfactant comprising an ethoxylated oleyl alcohol phosphate ester surfactant, which is assumed to be hydrolyzed to nonionic ˜4 EO oleyl alcohol in acid. The viscosity of the solution was measured on an OFITE™ 900 model viscometer at ambient temperature. Viscosity data is shown in Table 5.

TABLE 5
Effect of acid spending with CaCO₃ on the viscosity of solutions
containing 0.5 wt % SB3-18, 0.1 wt % AT Premix 4, 0.04 wt
% n-octanol, and 0.05 wt % of a secondary surfactant

| wt % HCl | Viscosity of solution in cP at | | |
|---|---|---|---|
| remaining | 511 s⁻¹ | 170 s⁻¹ | 100 s⁻¹ |
| 15.0* | | | |
| 11.8 | 1.3 | 2.1 | 2.6 |
| 8.5 | 1.3 | 2.2 | 2.4 |
| 5.1 | 11.8 | 24.0 | 32.8 |
| 1.9 | 27.5 | 60.7 | 101.6 |
| 1.5 | 28.0 | 59.3 | 96.2 |
| 1.2 | 31.7 | 66.9 | 103.9 |
| 0.8 | 32.2 | 57.4 | 86.7 |
| 0.4 | 34.6 | 56.7 | 76.6 |
| 0.0 | 19.9 | 33.9 | 49.5 |

*Initial concentration of live acid in solution before reaction with CaCO₃

As may be seen by comparing Tables 4 and 5, the addition of a secondary surfactant increased the viscosity of the fluid throughout the range, and particularly at higher concentrations of acid.

### Example 6

### Effect of Mixing Order on Viscosity of Spent Acid Solutions Containing Surfactant, Associative Thickener, Short Chain Alcohol, and a Secondary Surfactant

A 15 wt % HCl solution was reacted with a known amount of CaCO₃ until 2.0 wt % HCl remained (as determined by titration to a phenolphthalein endpoint with 1 M NaOH). For each sample prepared, 200 mL of the pre-spent hydrochloric acid solution was placed in a 400 mL plastic beaker and the contents mixed at 1000 rpm on a Caframo™ overhead stirrer equipped with a three-bladed propeller assembly. Chemical additives were added to the spent acid fluid in one of the three orders described below while mixing at 1000 rpm.

Mixing Orders:
1. “AT→Surfactant”: Add AT Premix 4 (8 L/m³)→mix 30 sec Add SB3-18 Surfactant Solution (15 L/m³)→mix 90 sec;
2. “Surfactant→AT”: Add SB3-18 Surfactant Solution (15 L/m³)→mix 30 sec→Add AT Premix 4 (8 L/m³)→mix 90 sec;
3. “Surfactant+AT”: Add AT Premix 4 (8 L/m³) and SB3-18 Surfactant Solution (15 L/m³) at same time→mix 120 sec.

The viscosity of each solution was measured on an OFITE™ 900 model viscometer at ambient temperature. Viscosity data is shown in Table 6.

TABLE 6
Effect of mixing order on viscosity of spent acid solutions
containing 0.5 wt % SB3-18, 0.7 wt % AT Premix 4, 0.04 wt
% n-octanol, and 0.05 wt % of a secondary surfactant

Viscosity of solution in cP at

| Mixing Order | 511 s⁻¹ | 170 s⁻¹ | 100 s⁻¹ | 10 s⁻¹ |
|---|---|---|---|---|
| AT → Surfactant | 22.7 | 46.8 | 79.3 | 791.6 |
| Surfactant → AT | 22.6 | 48.9 | 77.4 | 790.2 |
| (Surfactant + AT) | 23.8 | 49.8 | 78.9 | 813.3 |

As may be seen from Table 6, the order of mixing of the active material had little effect on the viscosity of the SDA fluid.

### Example 7

### Effect of Surfactant Modifications on SDA Viscosity in Spent Acid Solution

Changing the composition of the hydrophobic tail and the tether of the zwitterionic head group of the sulfobetaine surfactant may affect the resulting SDA viscosity in spent acid solutions. The sulfobetaine in this example was TAHS.

Pre-spent acid solutions were made by adding known quantities of powdered calcium carbonate to known volumes of 15 wt % HCl solutions and allowing the neutralization reaction to finish before adding the SDA additives. Spent acid strength was determined by titrating each solution with 1 M NaOH to a phenolphthalein endpoint to confirm the resulting acid concentration. Surfactant Solution and AT Premix loadings were held constant at 15 L/m³ and 8 L/m³, respectively.

200 mL of pre-spent hydrochloric acid solution was placed in a 400 mL plastic beaker and the contents mixed at 1000 rpm on a Caframo™ overhead stirrer equipped with a three-bladed propeller assembly. AT Premix 4 (1.6 mL, 8 L/m³) was added to the beaker by syringe and stirred at 1000 rpm for 30 seconds, after which the TAHS Solution (3.0 mL, 15 L/m³) was added to the beaker and mixed for an additional 90 seconds. The viscosity of the solution was measured on an OFITE™ 900 model viscometer at ambient temperature. Viscosity data are shown in Table 7.

TABLE 7
Effect of acid spending with CaCO₃ on the viscosity
of solutions containing 15 L/m³ TAHS Surfactant Solution
and 8 L/m³ AT Premix 4

| | |
|---|---|
| % HCl | Viscosity of solution in cP at |

| remaining | 511 s⁻¹ | 170 s⁻¹ | 100 s⁻¹ | 10 s⁻¹ |
|---|---|---|---|---|
| 15.0* | 0.9 | 0.8 | 0.9 | 0.0 |
| 11.3 | 1.1 | 1.4 | 1.6 | 0.0 |
| 8.4 | 1.8 | 1.5 | 2.4 | 17.0 |
| 2.2 | 25.2 | 55.5 | 89.5 | 839.7 |
| 1.9 | 27.4 | 57.4 | 24.9 | 858.9 |
| 1.2 | 29.0 | 21.5 | 79.4 | 752.9 |
| 0.8 | 31.1 | 52.0 | 85.2 | 782.3 |
| 0.5 | 27.2 | 46.0 | 76.9 | 660.5 |
| 0.0 | 19.9 | 34.1 | 46.2 | 361.4 |

*Initial concentration of live acid in solution before reaction with CaCO₃

### Example 8

### Effect of Surfactant/Associative Thickener Ratio on Viscosity of Self-Diverted Acid in Spent Acid Fluids

This series of experiments was conducted to demonstrate how the viscosity of the self-diverted acid fluid in spent acid changes as the ratio of surfactant solution to associative thickener premix is varied. Acid concentration and surfactant solution loadings were held constant, while the associative thickener premix loading was varied.

A solution of spent hydrochloric acid was made by adding a known quantity of powdered calcium carbonate to a 15 wt % HCl solution and allowing all of the CaCO₃ to be consumed. The final acid concentration after the reaction was complete was 1.1 wt % HCl. 100 mL of the pre-spent hydrochloric acid solution (1.1 wt % HCl remaining) was placed in a 400 mL plastic beaker and the contents mixed at 1000 rpm on a Caframo™ overhead stirrer equipped with a three-bladed propeller assembly. AT Premix 3 was added to the beaker by syringe and stirred at 1000 rpm for 30 seconds, after which SB3-18 Surfactant Solution was added to the beaker and mixed for an additional 90 seconds. The viscosity of the solution was measured on an OFITE™ 900 model viscometer at ambient temperature. SDA component loadings and viscosity data are shown in Table 8; the Surfactant Solution loading was held constant (at 15 L/m³) while the AT Premix 3 loadings were increased.

TABLE 8
Effect of Surfactant Solution/AT Premix 3 ratio on viscosity of
spent acid solutions (15 wt % HCl spent to 1.1 wt % with CaCO₃)

| Surfactant | AT | Surfactant/ | | | |
|---|---|---|---|---|---|
| Sol'n | Premix 3 | AT Premix | Viscosity of solution in cP at | | |
| (L/m³) | (L/m³) | Ratio | 511 s⁻¹ | 170 s⁻¹ | 100 s⁻¹ |
| 15 | 0 | ∞ | 0.8 | 2.2 | 3.5 |
| 15 | 4 | 3.8 | 2.8 | 4.3 | 6.4 |
| 15 | 6 | 2.5 | 4.0 | 3.7 | 4.0 |
| 15 | 8 | 1.9 | 14.4 | 28.2 | 47.5 |
| 15 | 10 | 1.5 | 13.7 | 18.5 | 24.0 |
| 15 | 12 | 1.3 | 15.8 | 24.9 | 36.5 |
| 15 | 14 | 1.1 | 19.4 | 29.6 | 37.0 |
| 15 | 16 | 0.9 | 22.9 | 35.2 | 49.5 |
| 15 | 18 | 0.8 | 24.8 | 39.3 | 52.1 |

As may be seen, significant viscosity developed at a premix volume ratio of about 2.0 or less, which equates to a weight ratio of about 5.3 or less.

### Example 9

### Effect of Surfactant/Short Chain Alcohol Ratio on Viscosity of Self-Diverted Acid in Spent Acid Fluids

This series of experiments was conducted to demonstrate how the viscosity of the self-diverted acid fluid in spent acid changes as the amount of short chain alcohol incorporated into the SDA is varied. Acid concentration and total SDA loadings were held constant, but the n-octanol content in the associative thickener premix was varied.

Variation in n-Octanol content in the associative thickener premixes (AT Premixes 3 and 5-12) was compensated for by changing the mass of deionized water in the premix. This is in contrast to the method used to prepare AT Premix 1 (no n-octanol), in which the mass of iso-propanol was increased to compensate for the missing n-octanol. All AT premixes employed here were mixed thoroughly before use.

A solution of spent hydrochloric acid was made by adding a known quantity of powdered calcium carbonate to a 15 wt % HCl solution and allowing all of the CaCO₃ to be consumed. The final acid concentration after the reaction was complete was 1.1 wt % HCl. Surfactant Solution and AT Premix loadings were held constant at 1.9 (15 L/m³ and 8 L/m³, respectively).

Subsequently, 100 mL of the pre-spent hydrochloric acid solution (1.1 wt % HCl remaining) was placed in a 400 mL plastic beaker and the contents mixed at 1000 rpm on a Caframo™ overhead stirrer equipped with a three-bladed propeller assembly. AT Premix (0.8 mL, 8 L/m³, selected from AT Premix 3, 5-12)) was added to the beaker by syringe and stirred at 1000 rpm for 30 seconds, after which SB3-18 Surfactant Solution (1.5 mL, 15 L/m³) was added to the beaker and mixed for an additional 90 seconds. The viscosity of the solution was measured on an OFITE™ 900 model viscometer at ambient temperature. Viscosity data are shown in Table 9 as a function of wt % n-octanol in the AT Premix and the molar ratio of 5B3-18/n-octanol in the SDA fluid.

TABLE 9
Effect of n-octanol content on viscosity of spent acid
solutions (15 wt % HCl spent to 1.1 wt % with CaCO₃)

| wt % | Mole Ratio | | | |
|---|---|---|---|---|
| n-Octanol | of Surfact/ | Viscosity of solution in cP at | | |
| in AT Premix | n-Octanol | 511 s⁻¹ | 170 s⁻¹ | 100 s⁻¹ |
| 0.0 | ∞ | 0.2 | 0.5 | 0.8 |
| 2.5 | 8.6 | 1.6 | 3.8 | 5.8 |
| 5.0 | 4.3 | 12.2 | 20.8 | 30.7 |
| 7.5 | 2.9 | 17.1 | 32.0 | 41.4 |
| 10.0 | 2.1 | 22.7 | 43.5 | 57.9 |
| 12.0 | 1.8 | 29.9 | 71.9 | 104.8 |
| 15.0 | 1.4 | 21.0 | 25.1 | 29.1 |
| 17.5 | 1.2 | 14.1 | 20.2 | 32.5 |
| 20.0 | 1.1 | 15.5 | 18.3 | 21.0 |

As may be seen from Table 9, viscosity peaked at a molar ratio of surfactant:n-octanol of 1.8, but substantial viscosity was achieved through a broad range of n-octanol content.

### Example 10

### Effect of Self-Diverted Acid Component Loading on Viscosity in Spent Acid Fluids

This series of experiments was conducted to demonstrate how the viscosity of the self-diverted acid fluid in spent acid increases with an increased loading of the component chemicals. The ratio of SDA additives and acid concentration of the spent acid base fluid were held constant so that the only difference would be in the total SDA additive loadings.

A solution of spent hydrochloric acid was made by adding a known quantity of powdered calcium carbonate to a 15 wt % HCl solution and allowing all of the CaCO₃ to be consumed. The final acid concentration after the reaction was complete was 1.1 wt % HCl.

Subsequently, 100 mL of the pre-spent hydrochloric acid solution (1.1 wt % HCl remaining) was placed in a 400 mL plastic beaker and the contents mixed at 1000 rpm on a Caframo™ overhead stirrer equipped with a three-bladed propeller assembly. AT Premix 3 was added to the beaker by syringe and stirred at 1000 rpm for 30 seconds, after which SB3-18 Surfactant Solution was added to the beaker and mixed for an additional 90 seconds. The viscosity of the solution was measured on an OFITE™ 900 model viscometer at ambient temperature. SDA component loadings and viscosity data are shown in Table 10; the ratio of Surfactant Solution to AT Premix 3 was held constant (at 1.9) while the total loadings were increased.

TABLE 10
Effect of SDA component loading on viscosity of spent acid
solutions (15 wt % HCl spent to 1.1 wt % with CaCO₃)

| | | |
|---|---|---|
| Surfactant | AT | |
| Solution | Premix 3 | Viscosity of solution in cP at |

| (L/m³) | (L/m³) | 511 s⁻¹ | 170 s⁻¹ | 100 s⁻¹ |
|---|---|---|---|---|
| 11 | 6 | 4.3 | 8.3 | 8.5 |
| 15 | 8 | 14.4 | 28.2 | 47.5 |
| 21 | 11 | 24.1 | 56.0 | 98.6 |
| 30 | 16 | 54.5 | 114.5 | 205.2 |
| 40 | 21 | 99.5 | 219.6 | 373.5 |

Surfactant Solution:AT Premix 3 ratio held at 1.9:1

### Example 11

### Effect of Secondary Surfactant on Viscosity of Self-Diverted Acid in Spent Acid Fluids

This example demonstrates how the degree of ethoxylation of the optional secondary surfactant affects the viscosity of the self-diverted acid fluid in spent acid. Acid concentration and total SDA loadings were held constant, while the ethoxylation level of the secondary surfactant component was varied.

A solution of spent hydrochloric acid was made by adding a known quantity of powdered calcium carbonate to a 15 wt % HCl solution and allowing all of the CaCO₃ to be consumed. The final acid concentration after the reaction was complete was 1.1 wt % HCl. Loadings of Surfactant Solution and AT Premixes 4 and 13 were held constant at 15 L/m³ and 8 L/m³, respectively.

Subsequently, 100 mL of the pre-spent hydrochloric acid solution (1.1 wt % HCl remaining) was placed in a 400 mL plastic beaker and the contents mixed at 1000 rpm on a Cafraino™ overhead stirrer equipped with a three-bladed propeller assembly. AT Premix 4 or AT Premix 13, (0.8 mL, 8 L/m³) was added to the beaker by syringe and stirred at 1000 rpm for 30 seconds, after which SB3-18 Surfactant Solution (1.5 mL, 15 L/m³) was added to the beaker and mixed for an additional 90 seconds. The viscosity of the solution was measured on an OFITE™ 900 model viscometer at ambient temperature. Viscosity data are shown in Table 11.

TABLE 11
Effect of degree of ethoxylation of optional secondary
surfactant on viscosity of spent acid solutions (15 wt
% HCl spent to 1.1 wt % with CaCO₃)

| | |
|---|---|
| Optional | |
| Secondary | Viscosity of solution in cP at |

| surfactant | 511 s⁻¹ | 170 s⁻¹ | 100 s⁻¹ | 10 s⁻¹ |
|---|---|---|---|---|
| 2 EO Oleyl | 20.0 | 34.0 | 52.7 | 518.2 |
| Alcohol | | | | |
| ~4 EO Oleyl | 25.9 | 50.8 | 78.5 | 711.4 |
| Alcohol* | | | | |

*Optional secondary surfactant is ethoxylated oleyl alcohol phosphate ester, presumed to be hydrolyzed to nonionic ~4 EO oleyl alcohol in acid.

### Example 12

### Effect of Short Chain Alcohol Chain Length on Viscosity of Self-Diverted Acid in Spent Acid Fluids

This example demonstrates how the carbon chain length of the short chain alcohol affects the viscosity of the self-diverted acid fluid in spent acid. Acid concentration and total SDA loadings were held constant, while the alcohol component was varied.

A solution of spent hydrochloric acid was made by adding a known quantity of powdered calcium carbonate to a 15 wt % HCl solution and allowing all of the CaCO₃ to be consumed. The final acid concentration after the reaction was complete was 1.1 wt % HCl. Surfactant Solution and AT Premix 2, AT Premix 3, and AT Premix 14 loadings were held constant at 15 L/m³ and 8 L/m³, respectively.

Subsequently, 100 mL of the pre-spent hydrochloric acid solution (1.1 wt % HCl remaining) was placed in a 400 mL plastic beaker and the contents mixed at 1000 rpm on a Caframo™ overhead stirrer equipped with a three-bladed propeller assembly. AT Premix (0.8 mL, 8 L/m³, selected from AT Premix 2, AT Premix 3, and AT Premix 14) was added to the beaker by syringe and stirred at 1000 rpm for 30 seconds, after which 5B3-18 Surfactant Solution (1.5 mL, 15 L/m³) was added to the beaker and mixed for an additional 90 seconds. Addition of 0.1 mL (n-butanol, n-hexanol) or 0.1 g (n-dodecanol, n-octadecanol) of an alcohol to an SDA solution prepared with AT Premix 2 was followed by mixing at 1000 rpm for an additional 2 minutes (see Table 12.1). The viscosity of the solution was measured on an OFITE™ 900 model viscometer at ambient temperature. Viscosity data are shown in Table 12.2.

TABLE 12.1
SDA components used to prepare test solutions

| Assoc. Thickener | Surfactant Solution | |
|---|---|---|
| Premix (8 L/m³) | (15 L/m³) | Alcohol |
| AT Premix 2 | SB3-18 Surfactant | None |
| AT Premix 2 | Solution | n-Butanol (0.1 mL) |
| AT Premix 2 | | n-Hexanol (0.1 mL) |
| AT Premix 14 | | 2-Ethyl-1-hexanol^{a} |
| AT Premix 3 | | n-Octanol^{a} |
| AT Premix 2 | | n-Dodecanol (0.1 g) |
| AT Premix 2 | | n-Octadecanol (0.1 g) |

^{a}AT premix contains approx 0.04 g of short chain alcohol

TABLE 12.2
Effect of alcohol chain length on viscosity of spent acid
solutions (15 wt % HCl spent to 1.1 wt % with CaCO₃)

Viscosity of solution in cP at

| Alcohol | 511 s⁻¹ | 170 s⁻¹ | 100 s⁻¹ | 10 s⁻¹ |
|---|---|---|---|---|
| None | 1.9 | 3.1 | 0.0 | 0.0 |
| n-Butanol | 1.9 | 1.0 | 1.0 | 0.0 |
| n-Hexanol | 17.0 | 25.5 | 34.9 | 147.8 |
| 2-Ethyl-1-Hexanol | 12.8 | 20.1 | 33.9 | 513.8 |
| n-Octanol | 13.1 | 24.4 | 40.6 | 382.6 |
| n-Dodecanol | 1.5 | 2.8 | 4.1 | 25.6 |
| n-Octadecanol | 2.1 | 2.7 | 3.9 | 21.9 |

### Example 13

### Effect of Hydrocarbons on Viscosity of Self-Diverted Acid in Spent Acid Fluids

This set of experiments was conducted to demonstrate that contact with hydrocarbons will break the viscosity of gelled SDA fluids in spent acid. Acid concentration and total SDA loadings were held constant.

A solution of spent hydrochloric acid was made by adding a known quantity of powdered calcium carbonate to a 15 wt % HCl solution and allowing all of the CaCO₃ to be consumed. The final acid concentration after the reaction was complete was 2.0 wt % HCl. Surfactant Solution and AT Premix 4 loadings were held constant at 15 L/m³ and 8 L/m³, respectively.

Subsequently, 200 mL of the pre-spent hydrochloric acid solution (2.0 wt % HCl remaining) was placed in a 400 mL plastic beaker and the contents mixed at 1000 rpm on a Caframo™ overhead stirrer equipped with a three-bladed propeller assembly. AT Premix 4 (1.6 mL, 8 L/m³) was added to the beaker by syringe and stirred at 1000 rpm for 30 seconds, after which SB3-18 Surfactant Solution (3.0 mL, 15 L/m³) was added to the beaker and mixed for an additional 90 seconds. The viscosity of the solution was measured on an OFITE™ 900 model viscometer at ambient temperature before dividing the solution into 2×100 mL portions. Hydrocarbon (1 mL) was added to a 100 mL portion of the gelled SDA fluid in a glass bottle and the bottle sealed and shaken vigorously until the gel viscosity broke. Initial and final viscosity data are shown in Table 13.

TABLE 13
Effect of hydrocarbons on viscosity of gelled
SDA fluids in 2.0 wt % HCl solution

| Hydrocarbon | Mix Time | Viscosity in cP at | | | |
|---|---|---|---|---|---|
| (1% v/v) | (min) | 511 s⁻¹ | 170 s⁻¹ | 100 s⁻¹ | 10 s⁻¹ |
| 2,2,4- | 0 | 22.6 | 48.9 | 77.4 | 790.2 |
| Trimethyl- | 2 | 1.4 | 1.2 | 0.6 | 0.0 |
| pentane | | | | | |
| Xylene | 0 | 23.8 | 49.8 | 78.9 | 813.3 |
| | 2 | 1.8 | 1.6 | 1.8 | 2.0 |
| Crude Oil | 0 | 23.8 | 49.8 | 78.9 | 813.3 |
| | 3 | 1.8 | 1.2 | 1.2 | 2.5 |

### Example 14

### Effect Of Acid Spending and Secondary Surfactant on the Viscosity Of SDA Solutions at Ambient Temperature

Acid spending was carried out in situ, by adding powdered calcium carbonate to an SDA fluid prepared in aqueous hydrochloric acid. Spent acid strength was calculated from the reaction stoichiometry based on the initial acid concentration and volume and the mass of CaCO₃ added. Surfactant Solution SB3-18 and AT Premix 3 and AT Premix 4 loadings were held constant at 15 L/m³ and 8 L/m³, respectively.

In this example, 200 mL of 15 wt % HCl was placed in a 400 mL plastic beaker and the contents mixed at 1000 rpm on a Caframo™ overhead stirrer equipped with a three-bladed propeller assembly. AT Premix 3 or AT Premix 4 (1.6 mL, 8 L/m³) was added to the beaker by syringe and stirred at 1000 rpm for 30 seconds, after which 3.0 mL of SB3-18 Surfactant Solution (15 L/m³) was added to the beaker and mixed for an additional 90 seconds. A pre-weighed portion of calcium carbonate powder (CaCO₃, ACS reagent grade) was added to the solution and allowed to react until most of the foam had dissipated, and then the viscosity of the solution was measured at ambient temperature. The calcium carbonate spending process was repeated until the acid was almost entirely spent. Viscosity data is shown in FIG. 1, and shows that the addition of a small quantity of a secondary surfactant (co-surfactant) has a significant impact on the observed viscosity of the SDA solution. In the presence of the secondary surfactant, viscosity onset occurs earlier in the acid spending process and the maximum viscosity at a shear rate of 10 s⁻¹ is approximately twice that of an equivalent SDA fluid that does not contain the secondary surfactant. FIG. 1 also demonstrates that the viscosity of the SDA fluid decreases significantly once the acid is spent at the completion of the well treatment.

### Example 15

### Effect of Temperature and Remaining Acid Strength

Pre-spent acid solutions were made by adding known quantities of powdered calcium carbonate to 15 wt % HCl solutions and allowing the neutralization reaction to finish before adding the SDA additives. Spent acid strength was determined by titrating the spent acid solutions with 1 M NaOH to a phenolphthalein endpoint. Surfactant Solution and AT Premix loadings were held constant at 15 L/m³ and 8 L/m³, respectively.

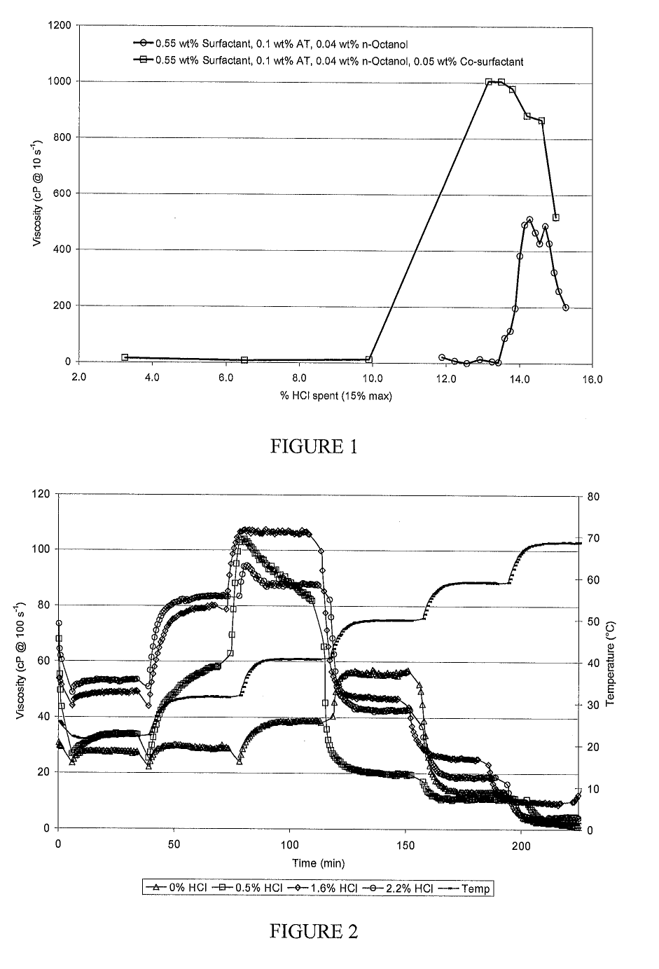

Subsequently, 100 mL of a pre-spent hydrochloric acid solution was placed in a 400 mL plastic beaker and the contents mixed at 1000 rpm on a Caframo™ overhead stirrer equipped with a three-bladed propeller assembly. AT Premix 4 (0.8 mL, 8 L/m³) was added to the beaker by syringe and stirred at 1000 rpm for 30 seconds, after which SB3-18 Surfactant Solution (1.5 mL, 15 L/m³) was added to the beaker and mixed for an additional 90 seconds. A 25 mL portion of the prepared solution was placed in a sample cup under 450 psi of nitrogen on a Brookfield™ Model PVS rheometer. Viscosity data was collected at a shear rate of 100 s⁻¹, applying a temperature ramp that comprised data collection for 30 minutes at each temperature. Viscosity data as a function of temperature and remaining acid strength are shown in FIG. 2. In almost all cases the highest viscosity was observed at 40° C. and decreased above this temperature. The exception to this trend is observed once all of the acid has been consumed by reaction with CaCO₃, at which point the solution loses viscosity at 30° C. and 40° C. with some viscosity recovery at 50° C. The loss of solution viscosity at 70° C. is reversible upon cooling and is presumed to be the result of a temperature-induced change in the surfactant/associative thickener network and not an irreversible degradation of the network components.

### Example 16

### Corrosion Rate of QT-800 Metal Coupons in 15 wt % HCl Self-Diverted Acid Fluids

This series of experiments was conducted to demonstrate that the self-diverted acid additives do not contribute to corrosion of metal coupons exposed to the acidic SDA fluids, and that the addition of a commercially available corrosion inhibitor can provide sufficient inhibition. Deionized water (vol=[50 mL−total volume of liquid additives]) was placed into a 175 mL glass bottle. Defoamer at 0.5 L/m³ was added to the water and then a corrosion inhibitor was added at the required loading (0, 1, or 5 L/m³), mixing well after each addition. Hydrochloric acid (28 wt % HCl, 50 mL) was added to the bottle and mixed well. AT Premix 14 (0.8 mL, 8 L/m³) was added to the acid blend and the mixture shaken well for 20 to 30 seconds, and then SB3-18 Surfactant Solution (1.5 mL, 15 L/m³) was added and the solution shaken for an additional 30 to 60 seconds. The resulting 15 wt % HCl SDA blends were allowed to stand undisturbed overnight to ensure that no separation or precipitation resulted. Subsequently, 100 mL of the prepared 15 wt % HCl SDA blend was placed in a Hastelloy™ autoclave cell with a QT-800 metal coupon. The cell was pressurized with mineral oil to 1500 psi and heated to 60° C. for 6 hrs. The mass of metal lost from the coupon during testing was used to calculate the corrosion rate in lb/ft² as shown in Table 16.

TABLE 16
Weight loss corrosion test results for QT-800 coupons
with 15% HCl SDA blends after 6 hours at 60° C.

| | |
|---|---|
| | 15% HCl |
| | Defoamer - 0.5 L/m³ |
| Acid Blend | AT Premix 14 - 8 L/m³ |
| Composition | SB3-18 Surfactant Solution - 15 L/m³ |

| | | | | | | |
|---|---|---|---|---|---|---|
| Corrosion | 0.0 | L/m³ | 1.0 | L/m³ | 5.0 | L/m³ |
| Inhibitor | | | | | | |
| Corrosion | 0.060 | lb/ft² | 0.0061 | lb/ft² | 0.0043 | lb/ft² |
| Rate | | | | | | |

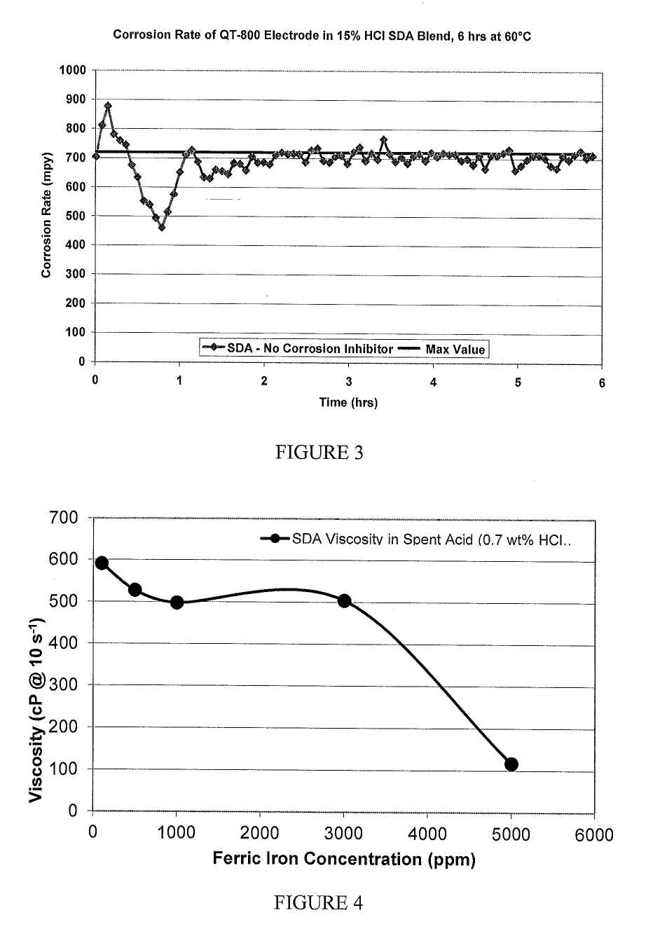

The corrosion rate of QT-800 metal submerged in a 15 wt % HCl SDA blend containing no additional corrosion inhibitor was also followed electrochemically. FIG. 3 shows the corrosion rate for a QT-800 electrode exposed to the SDA blend with no corrosion inhibitor for 6 hours at 60° C. The maximum acceptable corrosion rate of 720 mpy (mil per year, where one mil is one thousandth of an inch) is indicated by a solid black line. Even in the absence of an additional corrosion inhibitor the SDA blend is minimally corrosive to QT-800 metal with an average corrosion rate of 690 ropy, and as seen in Table 16, this rate is reduced further in the presence of a corrosion inhibitor.

### Example 17

### Effect of Acidizing Blend Additives on Viscosity of Self-Diverted Acid in Spent Acid Fluids

This experiment was conducted to demonstrate that the SDA is compatible with other functional additives that are commonly included in an acidizing treatment fluid. This experiment also demonstrates that the addition of ferric ions does not negatively impact viscosity development when iron control agents are included in the treatment fluid.

A partially spent acid solution (1.6 wt % HCl remaining) containing commercially available defoamer (0.05%) and corrosion inhibitor (0.6%), SB3-18 surfactant solution (1.5%), AT Premix 4 (0.8%), and a commercially available iron control agent in sufficient quantity to reduce ≧5000 ppm ferric iron was prepared. The defoamer, corrosion inhibitor, and iron control agent were added to the partially spent acid and the solution was mixed thoroughly between each addition. Once the base solution had been prepared, AT Premix 4 and SB3-18 Surfactant Solution were added to the fluid and mixed well between additions. The viscosity of the solution was measured on an OFITE™ 900 model viscometer at ambient temperature. Viscosity data are shown in Table 17.

A second sample of the above solution was prepared as described, followed by addition of 5000 ppm ferric iron. Reduction of ferric ions by the iron control agent was followed by monitoring the color of the spent acid solution; the reduction was considered complete once the bright yellow color of the ferric ions had disappeared. The viscosity of the solution was measured on an OFITE™ 900 model viscometer at ambient temperature. Viscosity data are shown in Table 17.

TABLE 17
Effect of functional additives on viscosity of SDA fluids
with and without added iron (1.6% HCl remaining)

Viscosity of solution in cP at

| SDA Solution^{a} | 511 s⁻¹ | 170 s⁻¹ | 100 s⁻¹ | 10 s⁻¹ |
|---|---|---|---|---|
| No added iron | 29.4 | 71.9 | 119.1 | 658.1 |
| 5000 ppm iron | 28.0 | 70.8 | 112.1 | 631.5 |

^{a}SDA solutions contain defoamer (0.05%), corrosion inhibitor (0.6%), SB3-18 Surfactant Solution (1.5%), AT Premix 4 (0.8%), and iron control agent sufficient to reduce ≧5000 ppm ferric iron

As shown in Table 17, properly selected functional additives commonly used in acid stimulation treatments can be incorporated into the SDA system without compromising gel viscosity. When suitable iron control is included in the blend design, contamination of the treatment fluid with ferric iron does not have a significant effect on the performance of the SDA system.

### Example 18

### SDA—Crude Oil Compatibility Tests

These tests were conducted to demonstrate that the SDA system does not cause unbreakable or difficult to break emulsions with crude oil. Two different samples of crude oil from central Alberta, Canada were used for acid compatibility testing with the SDA system. Neither of the two oils tested formed stable emulsions with the SDA blend even though the SDA blend did not contain additional demulsifying agents.

A 15 wt % HCl SDA blend was prepared with the following additives: defoamer (0.05%), corrosion inhibitor (0.6%), iron control agent (sufficient to control ≧5000 ppm ferric iron), AT Premix 4 (0.8%), and SB3-18 Surfactant Solution (1.5%).

The SDA acid blend and filtered oil sample were mixed in equal ratios in two separate glass bottles for 1 minute. One bottle was exposed to 5000 pm of ferric iron solution and the other was not. The bottles were then placed in a water bath at 60° C. and observed for acid-oil emulsion breaks. The times required for the emulsions to break were recorded as first break times. The bottles were then shaken again for 1 minute and placed back into the water bath at 60° C. The times required for the emulsions to break again were recorded as second break times.

The SDA-oil mixtures were then left in the water bath for 20 minutes at 60° C. The mixtures were poured through separate 200-mesh screens to check for sludge formation. The screened mixtures were then spent with calcium carbonate chips for 1 hour and subsequently observed for a spent acid emulsion break at 60° C.

TABLE 18
Acid-oil compatibility test results
for SDA blend in 15% HCl at 60° C.

| | Crude Oil #1 | | Crude Oil #2 | |
|---|---|---|---|---|
| | No Iron | 5000 ppm Iron | No Iron | 5000 ppm Iron |
| 1^{st} Live Break | 4 min | 4 min | 4 min | 8 min |
| 2^{nd} Live Break | 10 min | 6 min | 10 min | 4 min |
| Sludge | No | No | No | Yes^{a} |
| Spent Break | 3 min | 2.5 min | 7.5 min | 6 min |

^{a}Indicates that addition of an anti-sludging agent would be necessary

The ideal emulsion break time in live acid and spent acid should be less than ten minutes. In these examples all live breaks occurred within 10 minutes time. The mixture of acid and oil was screened to observe for the presence and evolution of sludge. No sludge was observed for crude oil #1 or for crude oil #2 in the absence of iron. Sludge formation was only observed for crude oil #2 in the presence of 5000 ppm iron, suggesting that the addition of an anti-sludging agent to the SDA blend would be beneficial for treating the formation which produced crude oil #2. Lastly, after the SDA-oil mixtures were spent using calcium carbonate chips, the spent breaks took less than 10 minutes to occur.

### Example 19

### Effect of Ferric Iron on Viscosity of Self-Diverted Acid in Spent Acid Fluid

This series of experiments was conducted to show how the concentration of ferric iron affects the viscosity of the SDA fluid in spent acid when no iron control agent is present. Acid concentration and total SDA active material loadings were held constant, while the ferric iron concentration was varied.

A solution of spent hydrochloric acid was made by adding a known quantity of powdered calcium carbonate to a 15 wt % HCl solution and allowing all of the CaCO₃ to be consumed. The final acid concentration after the reaction was complete was 0.7 wt % HCl. Loadings of SB3-18 Surfactant Solution and AT Premix 14 were held constant at 15 L/m³ and 8 L/m³, respectively. A stock solution containing 50,000 ppm ferric iron in 15 wt % HCl was used to adjust the ferric iron concentration of the test solutions.

Subsequently, 200 mL of the pre-spent hydrochloric acid solution (0.7 wt % HCl remaining) was placed in a 400 mL plastic beaker and the contents mixed at 1000 rpm on a Caframo™ overhead stirrer equipped with a three-bladed propeller assembly. The required volume of ferric iron stock solution was added to the beaker by syringe and allowed to mix. AT Premix 14 (1.6 mL, 8 L/m³) was added to the beaker by syringe and stirred at 1000 rpm for 30 seconds, after which SB3-18 Surfactant Solution (3.0 mL, 15 L/m³) was added to the beaker and mixed for an additional 90 seconds. The viscosity of the solution was measured on an OFITE™ 900 model viscometer at ambient temperature. Viscosity data (at 10 s⁻¹) as a function of ferric iron concentration are shown in FIG. 4 and demonstrate that ferric iron concentrations up to at least 3000 ppm do not significantly affect this SDA solution viscosity. At ferric iron concentrations above 3000 ppm, addition of a suitable iron control agent to the SDA fluid may be beneficial (see Example 17).

1. A fluid composition for acid stimulating a formation, the fluid comprising:
(a) an aqueous medium comprising an acid;
(b) a primary surfactant comprising a sulfobetaine which forms non-elongate micelles;
(c) an associative thickener comprising a polymer comprising at least one hydrophobic group and at least one hydrophilic group; and
(d) a short chain alcohol.

2. The composition of claim 1 further comprising a secondary surfactant.

3. The composition of claim 2 wherein the secondary surfactant comprises an anionic or non-ionic surfactant.

4. The composition of claim 1 wherein the short chain alcohol comprises a primary or secondary alcohol comprising 5 to 10 carbon atoms.

5. The composition of claim 4 wherein the short chain alcohol comprises any one or a mixture of the following: 2-ethyl-1-hexanol, n-hexanol, or n-octanol.

6. The composition of claim 1 wherein the sulfobetaine comprises a compound having the formula: R¹—N⁺(R²)₂—X—SO₃ wherein:
R¹ is a hydrophobic group having between about 10 to 24 carbon atoms, and is either branched or straight chained, is either saturated or unsaturated, and comprises a carbonyl, an amide, a retroamide, an imide, a urea, or an amine;
R² is each independently a hydrogen or a C₁ to about a C₆ aliphatic group which is either the same as or different from the other R², is either branched or straight chained, and is either saturated or unsaturated; and
X is a C₂ to C₆ tether, which is either substituted or unsubstituted, is either saturated or unsaturated, and is either linear or branched.

7. The composition of claim 6 wherein R² is methyl.

8. The composition of claim 6 wherein R¹ is an alkyl group having about 14 to about 20 carbon atoms.

9. The composition of claim 8 wherein R¹ comprises a straight chain alkyl group having 18 carbon atoms.

10. The composition of claim 8 wherein R¹ comprises an alkylamidopropyl group.

11. The composition of claim 1 wherein the at least one hydrophobic group of the polymer comprises at least two hydrophobic groups, and the at least one hydrophilic group of the polymer bridges the at least two hydrophobic groups.

12. The composition of claim 11 wherein each of the hydrophobic groups comprises a linear or branched C₁₂-C₂₂-alkyl, C₁₂-C₂₂-alkenyl or 2-hydroxy(C₁₂-C₂₂-alk-1-yl).

13. The composition of claim 11 wherein each hydrophilic bridging group comprises hydrophilic units comprising either polyether or polyvinyl alcohol, or both polyether and polyvinyl alcohol.

14. The composition of claim 13 wherein the hydrophilic units comprise a polyether unit —[(O—(CH₂)₂)_{y1}(O—CH(CH₃)CH₂)_{y2}]—-, wherein: the sequence of the alkyleneoxy units is as desired; y¹ and y² are each independently an integer from 0 to 300, and the sum of y¹ and y² is from 10 to 300.

15. The composition of claim 14 wherein the hydrophilic units are linked by multivalent γ bridging units.

16. The composition of claim 11 wherein the polymer has a molecular weight of between about 3000 g/mol to about 50000 g/mol.

17. The composition of claim 3 wherein the secondary surfactant comprises a compound having the formula: HO—Y—R³ wherein:
R³ is selected from either linear or branched C₁₆-C₂₂-alkyl, C₁₆-C₂₂-alkenyl, C₁₆-C₂₂-alkynyl, (C₁₅-C₂₁-alkyl)carbonyl, (C₁₅-C₂₁-alkenyl)carbonyl and (C₁₅-C₂₁-alkynyl)carbonyl; and
Y is a group consisting of 1 to 20 alkyleneoxy units, or a precursor thereof.

18. The composition of claim 1 further comprising any one or a combination of: a defoamer, a corrosion inhibitor, or an iron control agent.

19. The composition of claim 6 wherein the sulfobetaine comprises a compound having the formula:

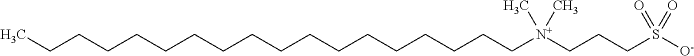 [SMILES: CCCCCCCCCCCCCCCCCC[N+](C)(C)CCCS(=O)(=O)[O-]]

20. The composition of claim 6 wherein the sulfobetaine comprises a compound having the formula: 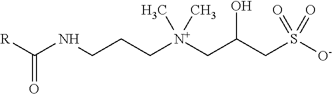
wherein R comprises a carbon chain derived from a tallow.

21. A method of acid stimulation of a subterranean formation, comprising the step of pumping into a wellbore an acidizing fluid comprising a composition as claimed in claim 1.

22. The method of claim 21 wherein the acidizing fluid is pumped at a pressure sufficiently low to avoid fracturing of the subterranean formation.

23. The method of claim 21 wherein the acidizing fluid is pumped at a pressure sufficiently high to fracture the subterranean formation.

24. A method of acid stimulation of a subterranean formation, comprising the step of pumping into a wellbore an acidizing fluid comprising a sulfobetaine surfactant which forms non-elongate micelles, a polymeric associative thickener, and a short chain alcohol, wherein the acidizing fluid comprises sufficient acid so as to be non-viscous when pumped into a wellbore and becomes viscous as acid is consumed by reaction with formation components and the pH of the fluid rises.

25. A method of acid stimulation of a subterranean formation, comprising the step of pumping into a wellbore an acidizing fluid comprising a sulfobetaine surfactant which forms non-elongate micelles, a polymeric associative thickener, and a short chain alcohol, wherein the fluid has a first viscosity at a pH of less than about 0.1, a second viscosity greater than the first viscosity at a pH of between about 0.1 to about 1.0, and a third viscosity intermediate to the first viscosity and the second viscosity at a pH above about 5.0.
